(19) United States
(12) Patent Application Publication
(10) Pub. No.: US 2018/0011315 A1
(43) Pub. Date: Jan. 11, 2018

(54) HEAD-UP DISPLAY APPARATUS

(71) Applicant: CALSONIC KANSEI CORPORATION, Saitama-shi, Saitama (JP)

(72) Inventors: Hideaki KAMIYAMA, Saitama-shi, Saitama (JP); Toshifumi TAKITA, Saitama-shi, Saitama (JP)

(21) Appl. No.: 15/546,640

(22) PCT Filed: Sep. 4, 2015
(86) PCT No.: PCT/JP2015/075198

§ 371 Date: Jul. 26, 2017

(30) Foreign Application Priority Data
Jan. 26, 2015 (JP) 2015-012318

(51) Int. Cl. G02B 27/01; B60K 35/00

(52) U.S. Cl. CPC G02B 27/0101; B60K 35/00; B60K 2350/901; B60K 2350/2095; B60K 2350/2065; B60K 2350/2052; B60K 2350/1072; G02B 2027/0127; B60K 2350/2069

(57) ABSTRACT

The present invention relates to a head-up display apparatus that projects an image of a displaying device forward. The displaying device includes a plurality of display surfaces. The direction of each of the display surfaces differs from the directions of the other display surfaces. At least one display surface is a reference display surface that projects an image in a vertical direction. Another surface is a stereoscopic inclination display surface that projects an image inclined relative to the image of the reference display surface.

### CROSS-REFERENCE TO RELATED APPLICATION

This application is based upon and claims the benefit of priority from Japanese Patent Application No. 2015-12318 filed to the Japan Patent Office on Jan. 26, 2015, the entire disclosure of which is incorporated herein by reference.

### TECHNICAL FIELD

The present invention relates to a head-up display apparatus.

### BACKGROUND ART

It is known that a vehicle such as an automobile includes a head-up display apparatus (Patent Literature 1, for example). The head-up display apparatus is configured to project an image of a displaying device forward.

The head-up display apparatus displays information in a field of view of an occupant or a driver who is driving the vehicle so that the occupant can obtain displayed information with little eye movement and little eye focus adjustment.

### CITATION LIST

### Patent Literature

Patent Literature 1: JP H05-56566 U

### SUMMARY

### Technical Problem

However, the above head-up display apparatus has a problem that the image of the displaying device is planar and monotonous. In particular, in a case where a traveling route is displayed, the planar image makes it difficult to grasp a sense of distance.

Accordingly, a main object of the present invention is to solve above problems.

### Solution to Problem

To overcome the above problem, according to the present invention, in a head-up display apparatus that projects an image of a displaying device forward,

the displaying device includes a plurality of display surfaces, each of which is oriented to a different direction,

at least one display surface of the display surfaces is a reference display surface that projects an image in a vertical direction, and

another display surface is a stereoscopic inclination display surface that projects an image inclined relative to the image of the reference display surface.

### Advantageous Effects

According to the present invention, the above configuration can make the image of the displaying device stereoscopic, diversified, and for example, easy to grasp the sense of distance.

### BRIEF DESCRIPTION OF DRAWINGS

FIG. 1 is a view of a vehicle cabin front portion illustrating a configuration of a head-up display apparatus of an embodiment of the present invention, which is viewed from a rear side in a vehicle longitudinal direction.

FIG. 2 is a vertical cross sectional view of the vehicle cabin front portion of FIG. 1.

FIG. 3 is an enlarged view of the head-up display apparatus of FIG. 1.

FIG. 4 is an exploded perspective view of the head-up display apparatus of FIG. 1.

FIG. 5 is a vertical cross sectional view of the head-up display apparatus of FIG. 1.

FIG. 6 is a perspective view of a displaying device in the head-up display apparatus of FIG. 1.

FIG. 7A is a cross sectional view of a first character/symbol plate of FIG. 6.

FIG. 7B is a cross sectional view of a second character/symbol plate of FIG. 6.

FIG. 8 is a plan view of a combiner showing an image of the head-up display apparatus of FIG. 1.

### DESCRIPTION OF EMBODIMENTS

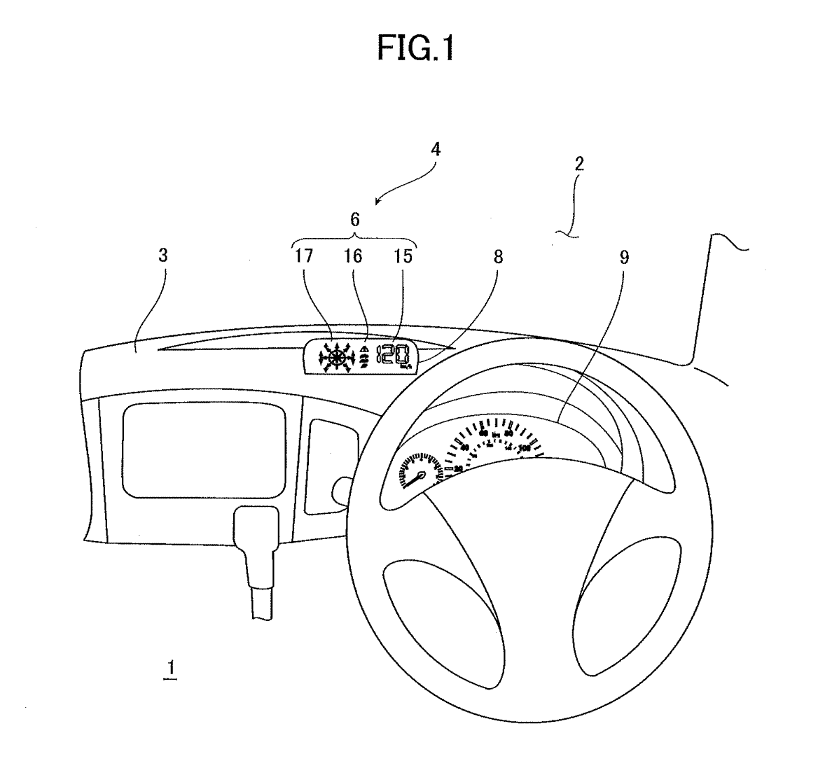

Hereinafter, an embodiment of the present invention is described in detail with reference to the drawings. FIGS. 1 to 8 illustrate this embodiment. Note that in following descriptions, front (forward), back (rear), left, and right are based on a vehicle longitudinal direction and a vehicle width direction. In addition, a near side and a far side are based on occupants facing forward in the vehicle longitudinal direction.

### Embodiment

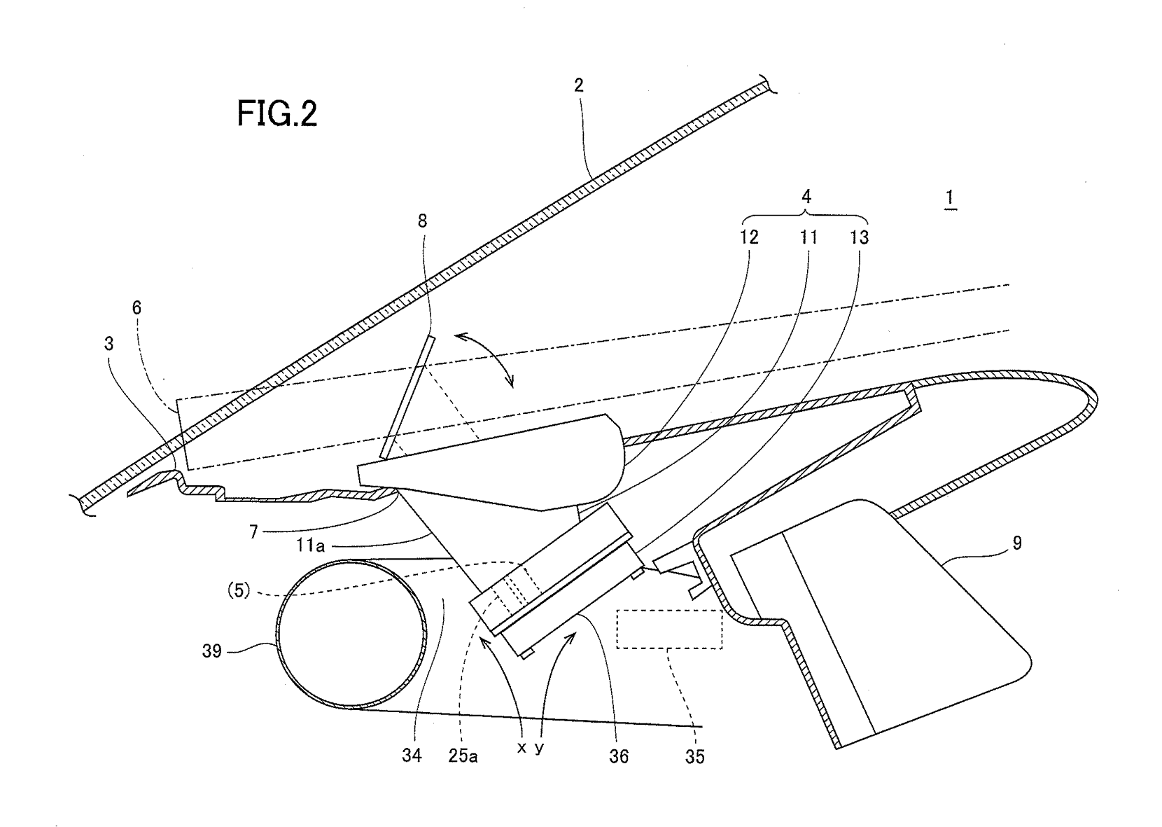

Hereinafter, configurations of this embodiment are described. As shown in an outline view illustrating from a rear side in FIG. 1, and in a cross sectional view of FIG. 2, a vehicle such as an automobile includes a windshield glass 2 in a front portion of a vehicle cabin 1. The vehicle includes an instrument panel 3 provided under the windshield glass 2.

The vehicle also includes a head-up display apparatus 4. The head-up display apparatus 4 is configured to project forward an indication or an image 6 of a displaying device 5 (see FIG. 2).

In this embodiment, the head-up display apparatus 4 is disposed in the instrument panel 3. The displaying device 5 is disposed in the head-up display apparatus 4. The instrument panel 3 includes an opening portion 7. Above the opening portion 7, a combiner 8 is disposed. The image of the displaying device 5 or displayed information is projected through the opening portion 7 (see FIG. 2) onto the combiner 8.

Here, in a driver's seat side of the instrument panel 3, a meter unit 9 such as an indicator or an instrument, and a steering wheel are provided. In this embodiment, the vehicle is a right-hand drive vehicle. However, this embodiment is applicable to a left-hand drive vehicle.

The head-up display apparatus 4 projects information necessary for an occupant or a driver to a position higher than a meter unit 9 within the field of view of the occupant who faces forward to drive the vehicle. The displaying device 5 is a device that displays information. As the displaying device 5, a display panel that displays images such as a liquid crystal panel and an organic EL panel may be used. The displaying device 5 used in this embodiment is described below. The opening portion 7 is formed in a driver side portion of the instrument panel 3 in advance. The opening portion 7 is placed above an installation position for the head-up display apparatus 4 in the instrument panel 3 such that the image 6 of the displaying device 5 is allowed to be projected through the opening portion 7.

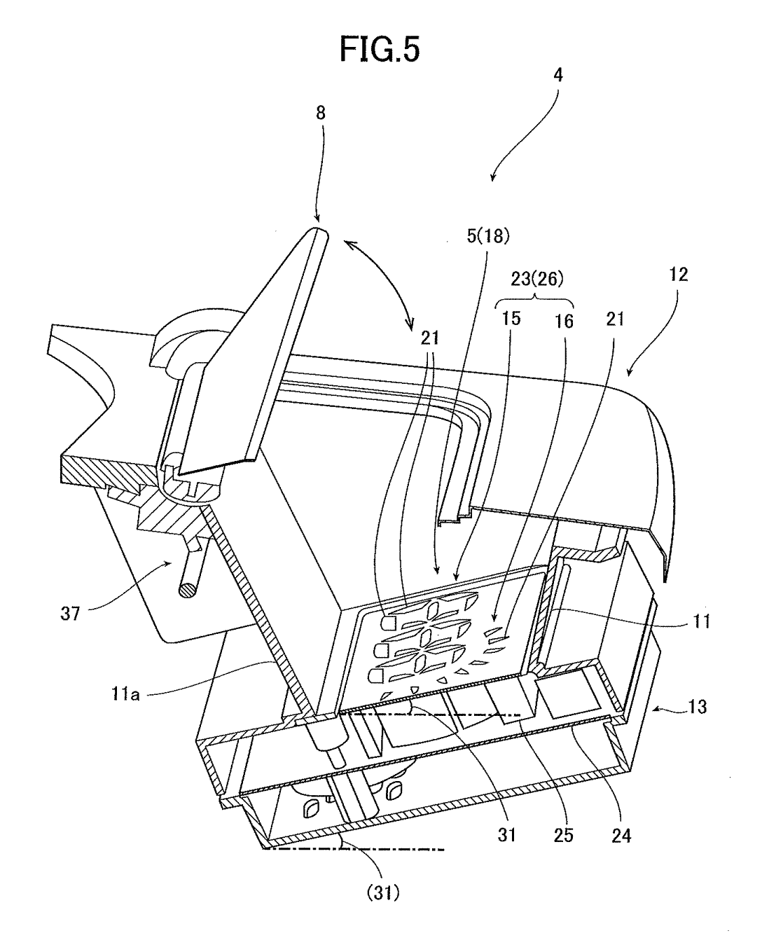

The combiner 8 is a reflection plate on which the image 6 of the displaying device 5 is projected. The combiner 8 forms, as a virtual image, the image 6 of the displaying device 5 in the front side or the back side of the combiner 8 at a position away from the combiner 8 by a distance corresponding to the distance between the combiner 8 and the displaying device 5 (see FIG. 2). Here, the angle of the combiner 8 is set to be the intermediate angle between a screen of the displaying device 5, which is arranged almost horizontally (see FIG. 5), and the formed image 6, which is projected in front of the combiner 8 almost vertically. Here, the image 6 of the displaying device 5 is projected to the combiner 8 in a state that the image 6 is inverted in the front-and-rear direction.

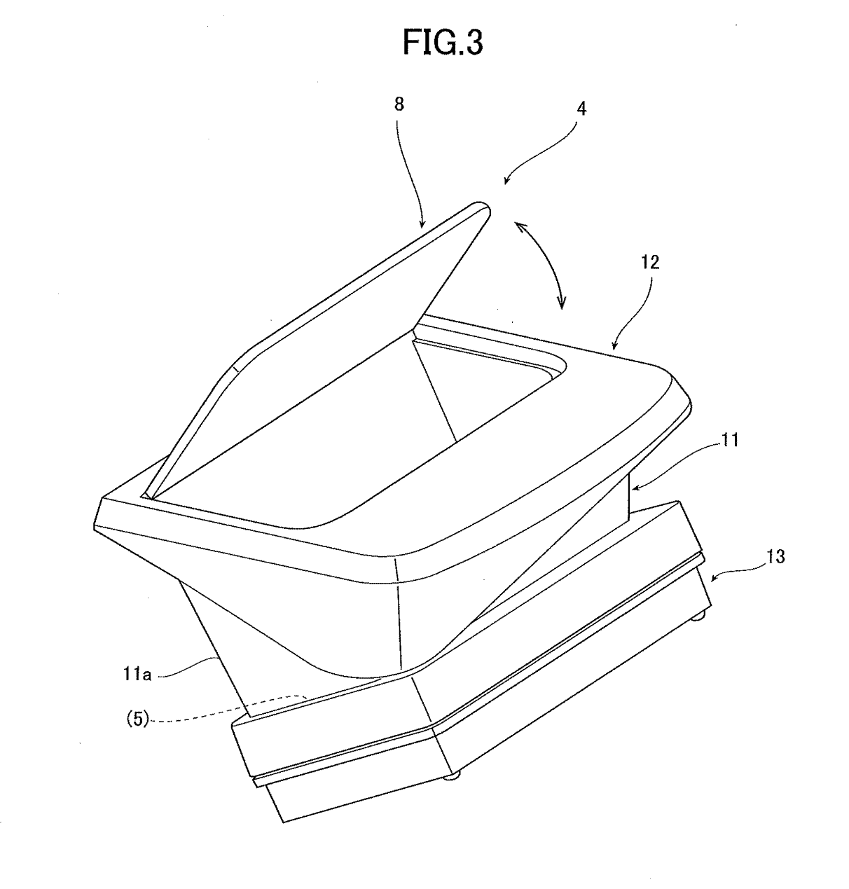

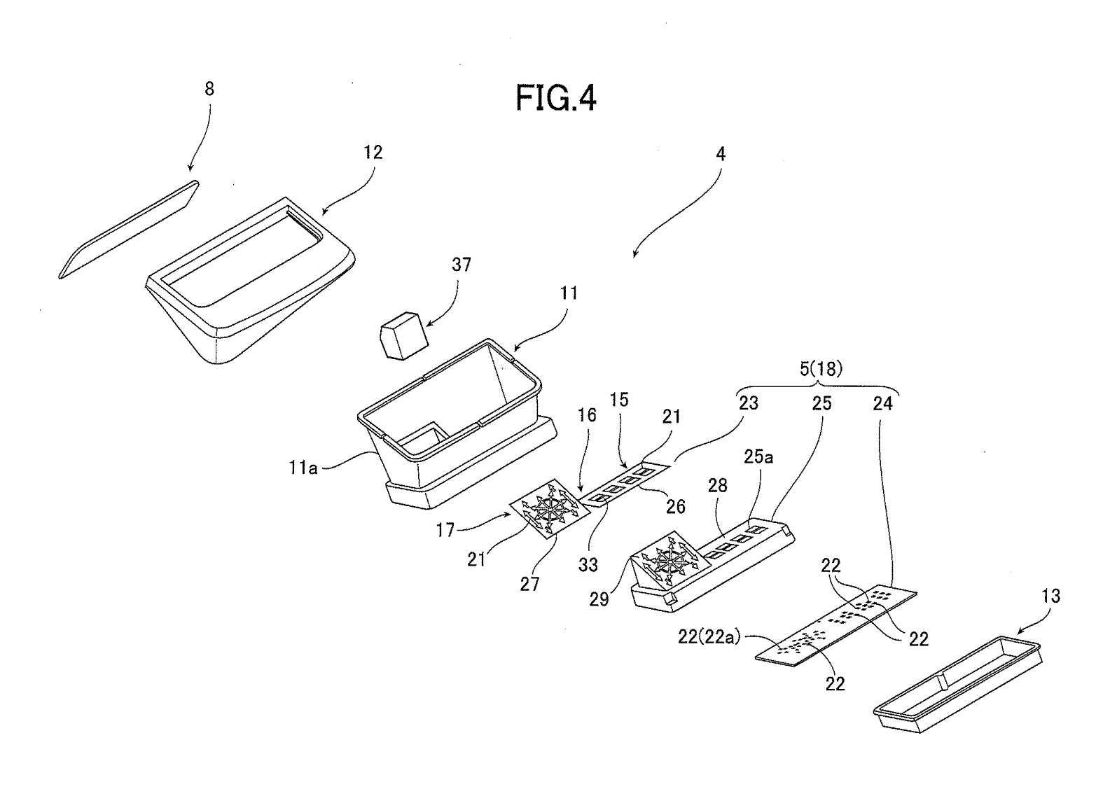

The head-up display apparatus 4 is configured as shown in FIG. 3 to FIG. 5. As shown in the exploded perspective view of FIG. 4, the head-up display apparatus 4 includes a casing 11, a finisher 12, the combiner 8, and a cover member 13. The casing 11 houses the displaying device 5. The finisher 12 is in a form of a frame and disposed in an opening provided in the upper end of the casing 11. The combiner 8 is openably and closably attached to the upper portion of the finisher 12. The cover member 13 or bottom cover is disposed in an opening provided in the bottom portion of the casing 11. The head-up display apparatus 4 is disposed to be inclined forward at an angle 31 within the instrument panel 3. Disposing the head-up display apparatus 4 to be inclined forward generates flows of air from the bottom to the top in the instrument panel 3 (see arrows x, y in FIG. 2). Accordingly, it can be expected to improve heat dissipation of heat generated by light sources 22 of the head-up display apparatus 4, or the like. Inside the instrument panel 3, an air conditioning duct 39, an electronic unit 35, and the like are installed in the front and rear spaces of the head-up display apparatus 4 inclined forward.

In this embodiment, the displaying device 5 is disposed upward in the bottom portion of the casing 11 such as to directly project the image 6 onto the combiner 8 through the straight light path extending upward. Accordingly, it is possible to shorten the light path in the casing 11, resulting in miniaturizing the casing 11 and simplifying the structure. The casing 11 has substantially an oblong square cylindrical shape in the plan view. The casing 11 includes side walls, namely a front wall 11a, a rear wall, a left wall, and a right wall. The casing 11 does not include reflecting portions or refracting portions for refracting the light path. Further, the casing 11 does not include a magnification optical apparatus so as to form the image 6 of the displaying device 5 at equal magnification.

It is known that the combiner 8 uses the windshield glass 2. For example, in such a combiner, the image 6 is projected onto a black printed portion provided in the bottom of the windshield glass 2 or a reflection coating attached to the windshield glass 2. However, in this embodiment, the combiner 8 is a flat plate made of a heat-resistant resin or glass and provided separate from the windshield glass 2. Generally, the combiner 8 includes a reflection enhancing film such as an expensive half mirror or a dielectric multilayer provided on a reflection surface of the combiner 8 to increase the surface reflectance to about 30% to 60% On the other hand, in this embodiment, the combiner 8 does not include a reflection enhancing film, or the like, and therefore the surface reflectance is kept low, for example about 7%. The combiner 8 is opened and closed by an opening/closing driving device 37 which is disposed within the casing 11.

The finisher 12 covers an edge of the opening portion 7 when the head-up display apparatus 4 is inserted to the opening portion 7 of the instrument panel 3 from above. Therefore, the finisher 12 is larger than the opening portion 7, and includes an overlapping portion on the lower end or the lower edge portion of the finisher 12. The overlapping portion has a three-dimensional shape corresponding to curves of the instrument panel 3.

The cover member 13 is provided separate from the casing 11, and disposed to form the bottom wall of the casing 11. In this embodiment, the cover member 13 is integrally assembled with the displaying device 5 which includes the character/symbol plate 23, the circuit board 24 and the light housing 25 to form a display unit, so that the display unit is attached to the casing 11 at one time. Note that the cover member 13 may be integrally formed with the casing 11 if structurally possible.

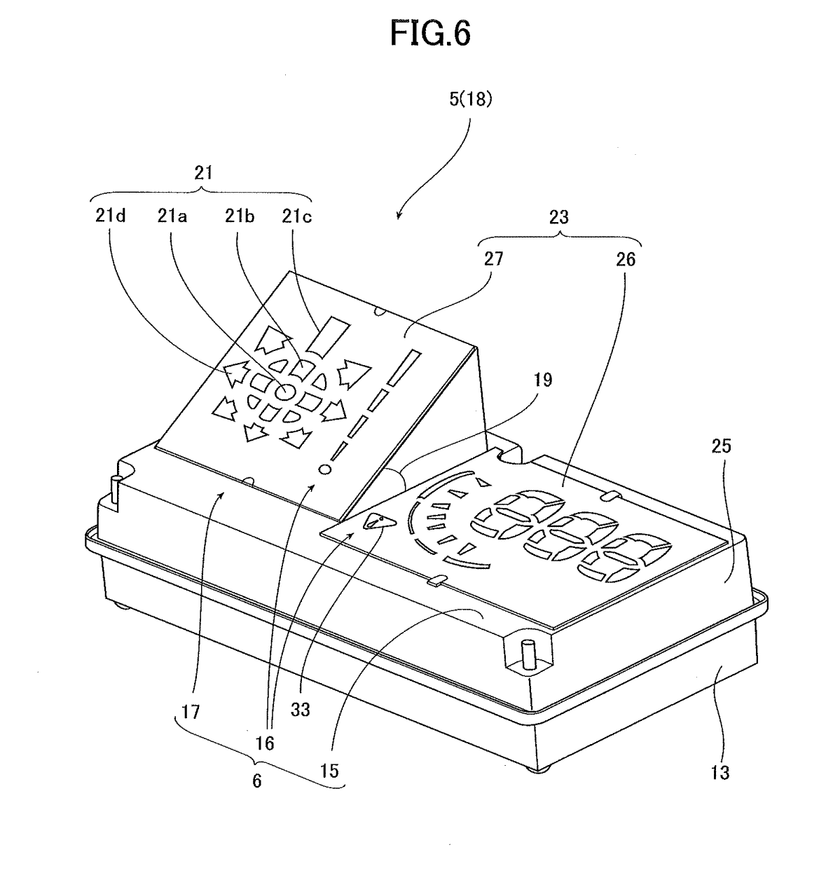

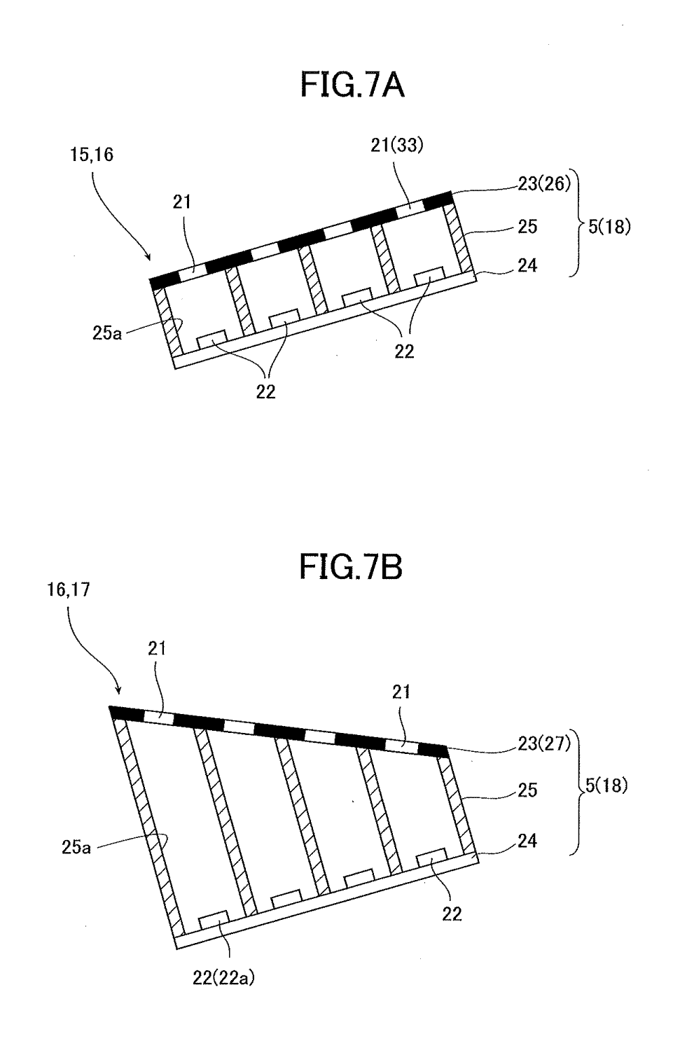

This embodiment further includes following configurations in addition to the basic configuration described above. (1) As shown in FIG. 6 and FIGS. 7A, 7B, the displaying device 5 includes a plurality of display surfaces, each of which is oriented to a different direction. At least one display surface is a reference display surface which projects the image 6 in a vertical direction. Another surface is a stereoscopic inclination display surface which projects the image 6 inclined relative to the image 6 of the reference display surface.

The display surfaces of the displaying device 5 include the character/symbol plate 23, for example. The display surfaces, each of which is oriented to a different direction, are formed by dividing the character/symbol plate 23 into a plurality of plates such as a first character/symbol plate 26, a second character/symbol plate 27, and the like. In this embodiment, the first character/symbol plate 26 is a reference display surface that projects the image 6 in a vertical direction. The second character/symbol plate 27 is a stereoscopic inclination display surface that projects the image 6 inclined relative to the image of the reference display surface. The vertical direction means that a direction of the surface is directed to a substantially vertical direction and a horizontal direction. However, the vertical direction is not necessary oriented in a perpendicular direction, and it may be inclined forward or backward within a range in which the inclination does not deteriorate visibility. In a case where an organic EL panel is used as the displaying device 5, two or more display surfaces can be formed with one organic EL panel since the organic EL panel can theoretically be folded or bended in use.

(2) The stereoscopic inclination display surface, for example, the second character/symbol plate 27 includes a route displaying part 17 that displays a traveling route.

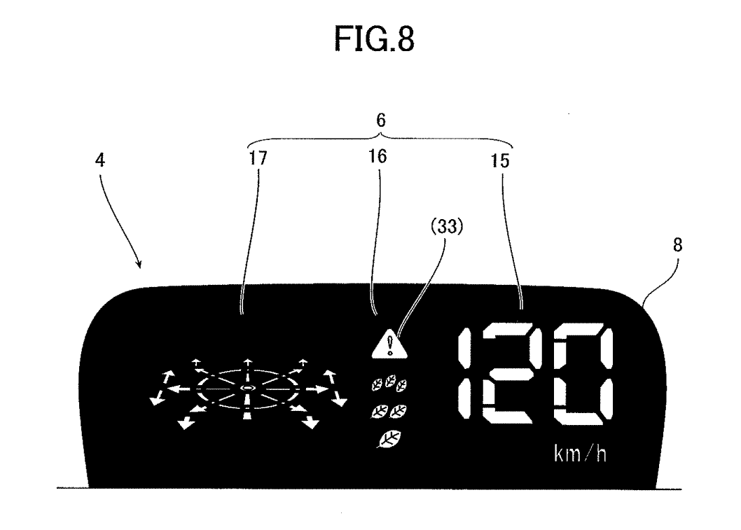

The route displaying part 17 displays a variety of traveling routes with points, lines, arrows, or the like. In this embodiment, the traveling route is a triple structure including a center point 21a (a first layer image), lines 21b (a second layer image), one line 21c, and seven arrows 21d (a third layer image). The center point 21a indicates an intersection. The lines 21b indicate eight roads extending in front, back, left, right, and oblique directions around the intersection, and connected thereto. The one line 21c is located outside of the point 21a and the lines 21b, and indicates the position of the vehicle on a near side. The seven arrows 21d indicate traveling directions. As shown in an exemplary image in FIG. 8, the route displaying part 17 may include figures and the like other than points, lines, and arrows.

(3) The stereoscopic inclination display surface, for example, the second character/symbol plate 27 is disposed to be inclined relative to the reference display surface, for example, the image 6 of the first character/symbol plate 26 at a stereoscopic inclination angle 19 that is capable of displaying the traveling route inclined forward.

In this embodiment, the second character/symbol plate 27 is inclined rearward at the stereoscopic inclination angle 19 such that the position of a rear edge of the second character/symbol plate 27 is substantially equal to that of the first character/symbol plate 26, and the position of a front edge is higher than that of the rear edge. Accordingly, the traveling route is displayed inclined forward. Resultingly, the traveling route is projected to be deformed into a shape having perspective as if the front side is narrower than the rear side.

In addition, distances from the first character/symbol plate 26 and the second character/symbol plate 27 to the combiner 8 differ from each other due to differences in the angles and the directions of the first and second character/symbol plates 26, 27 as described above. Accordingly, the image 6 of the first character/symbol plate 26 to be projected forward (for example, a meter displaying part 15 and a scale displaying part 16 as described later) is on the far side, and the image 6 of the second character/symbol plate 27 to be projected inclined forward (for example, the route displaying part 17) is on the near side. Therefore, each of the images 6 can have a different sense of distance and a different sense of depth from the other.

When the second character/symbol plate 27 is excessively inclined with respect to the first character/symbol plate 26, the images 6 of the first and second character/symbol plates 26, 27 interfere with each other so that some portions of the images 6 become invisible. Accordingly, the inclination angle of the second character/symbol plate 27 with respect to the first character/symbol plate 26 or the vertical plane is preferably limited to the stereoscopic inclination angle 19 having a predetermined angle (for example, within about 30 degrees±15 degrees) at which the invisible portions are moderated to an extent that does not bother an occupant.

(4) The route displaying part 17 has a brightness difference such that brightness on a near side of the traveling route becomes higher than brightness on a far side of the traveling route.

Here, the near side is a vehicle side and the far side is a traveling side. As described above, the image 6 of the displaying device 5 is projected onto the combiner 8 in a state that the image 6 is inverted in the front-and-rear direction. Accordingly, in the displaying device 5, the near side of the travel route is located on the far side as viewed from occupants (for example, on the front edge side of the second character/symbol plate 27), and the far side of the traveling route is located on the near side as viewed from the occupants (for example, on the rear edge side of the second character/symbol plate 27).

As will be described later, when the light sources 22 are used for the displaying device 5, the brightness difference may be generated with light sources 22 such as high brightness light sources 22a and/or low brightness light sources which have different brightness. Also, the brightness difference may be generated with the light sources 22 which have the same brightness but are modulated to have different brightness, or with the combination of the above light sources 22.

(5) The route displaying part 17 has a line width difference such that a width of a line on a near side of the traveling route becomes wider than a width of the line on a far side of the traveling route.

The line width difference may be generated by using figures of the traveling routes which are deformed such that the width of the line on the far side becomes thinner than that of the line on the near side by using the perspective method or the like. It is preferable to set the line width difference in accordance with the inclination of the route displaying part 17 to provide a natural perspective. However, it is also possible to emphasize the lines more.

(6) At least the route displaying part 17 is a segment display portion 18 that creates a plurality of kinds of images by turning on and off a plurality of display forming portions 21.

As the segment display portion 18 or the displaying device 5 equivalent to the segment display portion 18, a fluorescent tube type panel, a segment type liquid crystal panel, a passive matrix type liquid crystal panel, and the like may be used. In this embodiment, the segment display portion 18 includes a plurality of light sources 22 (see FIGS. 7A, 7B) as described above, and the character/symbol plate 23 having a plurality of the display forming portions 21. The segment display portion 18 of this embodiment is inexpensive compared to the above conventional panels and can increase brightness without increasing cost.

The display forming portions 21 are a plurality of light transmitting portions or segments provided on the character/symbol plate 23 to form a variety of the images 6 as described above. The display forming portions 21 may be partially or entirely colorless and transparent, or colored and transparent depending on purposes and contents of the images.

The light sources 22 individually display each of the display forming portions 21 by lighting up. As the light source 22, for example, a LED (or a light emitting diode) is used. As the LED, a white LED, a RGB full color LED, or the like may be used. The LEDs are attached to the circuit board 24.

In this embodiment, a single circuit board 24 is used to install the light sources 22 as shown in FIG. 4. The circuit board 24 is arranged substantially parallel to the first character/symbol plate 26 and the cover member 13 (see FIG. 7A). The brightness of the display forming portions 21 varies according to the distance between the light sources 22 and the character/symbol plate 23. Specifically, the display forming portions 21 become brighter when the distance is shorter, while the display forming portions 21 become dark when the distance is longer. When the single circuit board is used to illuminate two character/symbol plates 23 having different inclination angles at the same time, uneven brightness occurs in the first character/symbol plate 26 or the second character/symbol plate 27 (in this embodiment, the second character/symbol plate 27 in FIG. 7B) due to the difference of the distances. Therefore, the brightness of each of the light sources 22 is adjusted to obtain required brightness. However, it is possible to eliminate the adjustment of brightness described above, if a plurality of circuit boards 24 are respectively provided relative to the first character/symbol plate 26, the second character/symbol plate 27, and the like, and the respective distances are set to be constant.

The character/symbol plate 23 is formed by providing a non-translucent printing layer on a transparent resin plate to leave the display forming portions 21, for example.

Note that the character/symbol plate 23 and/or the circuit board 24 may be divided into three or more pieces, and each of the pieces may be directed in a direction different from the others.

Further, a light housing 25 is provided between the light sources 22 and the character/symbol plate 23. The light housing 25 guides or directs light from each of the light sources 22 to each of the display forming portions 21.

The light housing 25 is installed between the circuit board 24 and the character/symbol plate 23 such as to contact the upper surface of the circuit board 24 and the lower surface of the character/symbol plate 23 without any gap. The light housing 25 includes a plurality of light guiding holes 25a each of which is separate from others to correspond to each of the light sources 22. The light housing 25 is made of a white resin having a smooth surface with high reflectance, for example. Each of the display forming portions 21 is formed at a position which coincides with each of the light guiding holes 25a.

When the character/symbol plate 23 is divided into the first character/symbol plate 26, the second character/symbol plate 27, or more, the upper surface of the light housing 25 has abutting surfaces 28, 29 or an inclined surface portion (see FIG. 4) separate from each other to correspond to the first character/symbol plate 26, the second character/symbol plate 27, or the like.

Preferably, as shown in FIG. 8, a non-translucent black plate or a semi-translucent black smoke plate is used for the combiner 8. That is, the combiner 8 includes black color. The black plate has a light transmittance of 0% or close to 0%. The black smoke plate is not colorless and transparent. However, for the combiner 8, a colorless and transparent combiner may be used. In this embodiment, it is preferable to form a reflection enhancing film on the surface of the colorless and transparent combiner 8.

(7) As shown in FIG. 6, the reference display surface (for example, the first character/symbol plate 26) includes a meter displaying part 15 that is capable of displaying numerals.

The meter displaying part 15 is capable of displaying a vehicle speed, an engine speed, and the like with numerals. For example, with regard to the meter displaying part 15, the display forming portions 21 may be configured as a seven-segment type display portion having seven segments arranged in the form of a numeral “8”.

The reference display surface includes a scale displaying part 16 having a plurality of scales, etc. With regard to the scale displaying part 16, the display forming portions 21 may be configured by continuously arranging a plurality of segments in a bar graph form or the like. For example, in FIG. 6, the scales indicate a fuel remaining amount, and the like. Further, a single separate segment forms a warning display portion 33. The warning display portion 33 is provided on the upper portion of the first character/symbol plate 26 inclined forward with the angle 31.

In the example of FIG. 8, a plurality of segments in the form of leaves are arranged to indicate an energy-saving driving condition, for example. Alternatively, as shown in FIG. 6, the scale displaying part 16 may be provided relative to the stereoscopic inclination display surface, for example, the second character/symbol plate 27. In this embodiment, the scale displaying part 16 is a distance counter or the like that indicates distance to a destination with the number of illuminated segments, lighting patterns, or the like.

Note that the display forming portions 21 provided on the reference display surface or the stereoscopic inclination display surface may include, for example, a description (for example, km/h) with the alphabet or Chinese (or Kanji) characters other than described above

According to this embodiment, following operations and effects can be obtained.

In this embodiment, the head-up display apparatus 4 is configured to project the image of the displaying device 5 through the opening portion 7 disposed in the instrument panel 3 onto the combiner 8 disposed above the opening portion 7, and to form a virtual image on the front side of the combiner 8 such that an occupant can see the image 6. The head-up display apparatus 4 displays information in a field of view of the occupant who is driving the vehicle so that the occupant can obtain the displayed information with little eye movement and little eye focus adjustment.

(1) The displaying device 5 of the head-up display apparatus 4 includes a plurality of display surfaces or the character/symbol plate 23, each of which is oriented to a different direction. The display surfaces include the reference display surface (the first character/symbol plate 26, for example) and the stereoscopic inclination display surface (the second character/symbol plate 27, for example). Thereby, the reference display surface projects the image 6 in a vertical direction, and the stereoscopic inclination display surface projects the image 6 inclined to be viewed stereoscopically relative to the image 6 of the reference display surface. As a result, the image 6 of the reference display surface and the image 6 of the stereoscopic inclination display surface can have completely different visual effects to make the images 6 of the displaying device 5 diversified and non-monotonous. Therefore, the commercial value of the head-up display apparatus 4 can be increased.

(2) The stereoscopic inclination display surface (the second character/symbol plate 27, for example) includes the route displaying part 17. In addition, the traveling routes of the route displaying part 17 are projected inclined relative to the image 6 of the reference display surface (the first character/symbol plate 26, for example). Accordingly, the traveling routes can be shown stereoscopically.

(3) The stereoscopic inclination display surface (the second character/symbol plate 27, for example) is disposed to be inclined at the stereoscopic inclination angle 19 so that the traveling routes can be displayed inclined forward. Accordingly, the traveling routes can have a stereoscopic effect and a sense of depth that are the same as the actual road condition occupants see in front of the vehicle, resulting in easy to grasp a sense of the distance of the traveling routes.

(4) The traveling routes of the route displaying part 17 have a brightness difference. Accordingly, the stereoscopic effect and the sense of depth can be emphasized with the brightness difference. Specifically, the brightness on the near side becomes higher than the brightness on the far side. As a result, the images 6 can be easy to see and perceive, and make a sense of the distance easy to grasp.

(5) The traveling routes of the route displaying part 17 have a line width difference. Accordingly, the stereoscopic effect and the sense of depth can be emphasized with the line width difference. Specifically, the width of the line on the near side becomes wider than that of the line on the far side. As a result, the images 6 can be easy to see and perceive, and make a sense of the distance easy to grasp.

(6) At least the route displaying part 17 is a segment display portion 18. The segment display portion 18 can display the traveling routes with high brightness and clear contour, resulting in easy to see the traveling routes of the route displaying part 17 regardless of brightness outside the vehicle or the condition of outside lights. As described above, when providing the brightness difference or the line width difference to the images, it is possible to effectively show the brightness difference and the line width difference.

Further, combining the segment display portion 18 with the combiner 8 which is a non-translucent black plate or a semi-translucent black smoke plate can further enhance the above effects. The above combination can also suppress or reduce the generation of a double image, and/or the pseudo lighting phenomenon in which the lit-off segments may be seen as if the segments are lit up.

In addition, the image of the segment display portion 18 differs from that of the display panel such as a liquid crystal panel, and the segment display portion 18 only displays the traveling routes and is limited to one image content. Therefore, when the segment display portion 18 for showing a specific image is disposed to be inclined, the segment display portion 18 is used only for its original purpose. Accordingly, the inclined disposition effectively exhibits display effects.

On the other hand, the display panel such as the liquid crystal panel may display different contents on the same screen. Therefore, the screen displaying the travel routes may show an image other than the traveling routes. Accordingly, when the panel shows an image other than the traveling routes, perspective generated by the inclined disposition may interfere with the image other than the traveling routes. As a result, the inclined disposition is not suitable for the display panel such as the liquid crystal panel.

(7) The reference display surface (the first character/symbol plate 26, for example) includes a meter displaying part 15. Accordingly, the meter displaying part 15 in a vertical direction can display numeral information such as a vehicle speed, an engine speed, or the like to be easy to see it. In addition, providing the meter displaying part 15 on the reference display surface can emphatically show the stereoscopic effects and/or the depth sense of the image (figures such as the traveling routes, for example) of the stereoscopic inclination display surface (the second character/symbol plate 27, for example) by contrast effects relative to the image 6 (for example, numerals such as vehicle speed, engine speed) of the meter displaying part 15.

While the embodiments have been described in detail with reference to the drawings, the embodiments are only illustrative and exemplary of the invention. Accordingly, the invention is not limited to the configurations of the embodiments. It will be appreciated that any design change and the like that do not depart from the gist should be included in the invention. It is to be understood that, when multiple configurations are incorporated in each of the embodiments, for example, possible combinations of these configurations are included in the invention without any particular description. It should further be understood that, when multiple embodiments and modifications are disclosed as those of the invention, any possible combinations of configurations among these embodiments and modifications are considered to be included in the invention without any particular description. Moreover, configurations disclosed in the drawings are naturally considered to be included in the invention without any particular description. Further, the term “and/or the like (such as)” is used to indicate that any equivalent is also included. Also, when such a term as “substantially”, “about”, or “approximately” is used, this means that a value or the like within a range or accuracy which is reasonably acceptable is also included.

### REFERENCE SIGNS LIST

4 Head-Up Display Apparatus,
5 Displaying Device,
6 Image,
15 Meter Displaying Part,
17 Route Displaying Part,
18 Segment Display Portion,
19 Stereoscopic Inclination Angle,
21 Display Forming Portions,
23 Character/Symbol Plate,
26 First Character/Symbol Plate,
27 Second Character/Symbol Plate

1. A head-up display apparatus that projects an image of a displaying device to a reflection plate disposed in front of a driver's seat, wherein
the displaying device includes a plurality of display surfaces, each of which is oriented to a different direction,
at least one display surface of the display surfaces is a reference display surface that projects an image in a vertical direction,
another display surface is a stereoscopic inclination display surface that projects an image inclined relative to the image of the reference display surface, and
the plurality of the display surfaces are configured to project each of the images directly to the reflection plate in front of the display surfaces.

2. The head-up display apparatus according to claim 1, wherein
the stereoscopic inclination display surface includes a route displaying part that displays a traveling route.

3. The head-up display apparatus according to claim 2, wherein
the stereoscopic inclination display surface is disposed to be inclined relative to the reference display surface at a stereoscopic inclination angle that is capable of displaying the traveling route inclined forward.

4. The head-up display apparatus according to claim 2, wherein
the route displaying part has a brightness difference such that brightness on a near side of the traveling route becomes higher than brightness on a far side of the traveling route.

5. The head-up display apparatus according to claim 2, wherein
the route displaying part has a line width difference such that a width of a line on a near side of the traveling route becomes wider than a width of the line on a far side of the traveling route.

6. The head-up display apparatus according to claim 2, wherein
the route displaying part has a brightness difference such that brightness on a near side of the traveling route becomes higher than brightness on a far side of the traveling route, and
the route displaying part has a line width difference such that a width of a line on a near side of the traveling route becomes wider than a width of the line on a far side of the traveling route.

7. The head-up display apparatus according to claim 2, wherein
at least the route displaying part is a segment display portion that creates a plurality of kinds of images by turning on and off a plurality of display forming portions

8. The head-up display apparatus according to claim 1, wherein
the reference display surface includes a meter displaying part that displays numerals

9. The head-up display apparatus according to claim 1, wherein
the plurality of displays are respectively disposed relative to surfaces having different inclination angles and disposed adjacent to a same light housing.

10. A head-up display apparatus that projects an image of a displaying device to a reflection plate disposed in front of a driver's seat, wherein
the plurality of displays are respectively disposed relative to surfaces having different inclination angles and disposed adjacent to a same light housing.
